(19) United States
(12) Patent Application Publication
(10) Pub. No.: US 2005/0198138 A1
(43) Pub. Date: Sep. 8, 2005

(54) Automation device comprising an interface for message-based and port-based accessing of an application

(76) Inventors: Rainer Heller, Eckental (DE); Thomas Jachmann, Nurnberg (DE); Norbert Portner, Feucht (DE)

Correspondence Address: Siemens Corporation;Intellectual Property Department, 170 Wood Avenue South, Iselin, NJ, 08830, US

(21) Appl. No.: 10/513,054

(22) PCT Filed: Apr. 16, 2003
(86) PCT No.: PCT/DE03/01291

§ 371 Date: Oct. 28, 2004

(30) Foreign Application Priority Data
Apr. 29, 2002 (DE) 102 19 092.5
Jul. 3, 2002 (DE) 102 29 878.5

(51) Int. Cl. G06F 15/16

(52) U.S. Cl. 709/205; 709/217

(57) ABSTRACT

The invention relates to an automation device and to an automation system provided with automation deices that enable the integration of automation devices that leads to a homogenous automation solution. The automation devices comprise at least one interface for the message-based and port-based access to at least one application provided by the automation device. This application provides a functionality, uses internet mechanisms, and the interface is written using meta-information. The applications of the automation devices in the automation system comprise means for directly communicating with one another.

### CROSS REFERENCE TO RELATED APPLICATIONS

This application is the US National Stage of International Application No. PCT/DE03/01291, filed Apr. 16, 2003 and claims the benefit thereof. The International Application claims the benefits of German application No. 10219092.5 filed Apr. 29, 2002, and of German application No. 10229878.5 filed Jul. 3, 2002, all three of the applications are incorporated by reference herein in their entirety.

### FIELD OF INVENTION

The invention relates to an automation device that makes a functionality available and to an automation system having a plurality of such automation devices.

### BACKGROUND OF INVENTION

Hitherto customary automation systems frequently contain a wide variety of automation devices from different manufacturers. Integrating said automation devices in an automation system is technically very demanding as the respective devices communicate via proprietary mechanisms. Different controls have to be addressed differently. Programmable logic controllers are, for example, frequently accessed via data modules and hence at a very “data-driven” level. Moreover, communication usually takes place over expensive, special buses for automation technology which frequently only offer a small bandwidth. As a result, a variety of special drivers are needed for accessing. Uniform or, as the case may be, shared services are either difficult or impossible to implement on a cross-system basis.

### SUMMARY OF INVENTION

The object of the invention is to enable automation devices to be integrated to provide a homogeneous automation solution.

Said object is achieved by means of an automation device having at least one interface for message-based and port-based accessing of at least one application provided by said automation device, with said application making a functionality available and employing internet mechanisms, and with said interface being described using meta information.

Said object is achieved by means an automation system which has automation devices according to one of claims 1 to 5 and in which the applications have means for communicating with one another directly.

The invention is based on the knowledge that the main focus in hitherto known automation systems is on data, not on the actual automation functionality. By contrast, the automation device according to the invention makes an application, and hence a functionality, available which can be addressed by means of message-based and port-based accessing via an interface. The application or, as the case may be, functionality is therefore independent of the respectively selected platform (such as a PC, mainframe, handheld, PLC, sensor, . . . ), of the operating system (such as Windows, Unix, . . . ), of the programming language (such as C#, VB, C++, Script, . . . ), and of the object model (such as COM, CORBA, . . . ). Separate, special accessing means have hitherto existed for each type of device in an automation system, resulting in the need to use special drivers in each case. Although an initial approach to a uniform driver interface for accessing automation data was realized with OPC (OLE for Process Control), OPC requires a proprietary, PC-based infrastructure. Actual communication with the devices takes place via proprietary drivers. OPC—in common with all other existing solutions—furthermore provides a data-driven view, which necessitates data-driven programming (instance data, data modules). The functionality in known systems has to be realized using a specific operating system, PC-based clients, or intelligent communication processors.

As web service technology is likely to have a significant impact on how the internet is used, it is proposed that the application of the automation device according to the invention should employ web service technology. Web services are characterized as follows: They are stateless, they employ internet standards and internet protocols, they are available to a large number of clients, and they are independent of programming language and platform. Web service technology has hitherto been used in e-Commerce and Business-to-Business applications. They currently play no role in the area of automation.

Embodying the interface of the automation device as an XML interface makes distributed and integrated internet applications possible and permits TCP/IP linking of the automation device.

Apart from the information stored in engineering systems, currently employed automation systems have no central component permitting an overview of existing automation devices and their properties (access, functionality). According to an advantageous embodiment of the automation device, said device has a memory area for storing such information about the application.

In an automation system having a plurality of automation devices according to the invention, the applications advantageously have means for communicating with one another directly. Said applications can therefore be accessed not only by external applications and users but also by other applications of the same automation system.

Distributed applications advantageously make a common functionality available in an automation system of this type. It is furthermore proposed that a central component in the automation system should have an overview of existing automation devices and their properties.

The invention is described and explained in more detail below with reference to the exemplary embodiments shown in the figures, in which:

### BRIEF DESCRIPTION OF THE DRAWINGS

FIG. 1 is a schematic showing the principle of using web services in automation devices, and

FIG. 2 shows the use of web services in a distributed automation system.

### DETAILED DESCRIPTION OF INVENTION

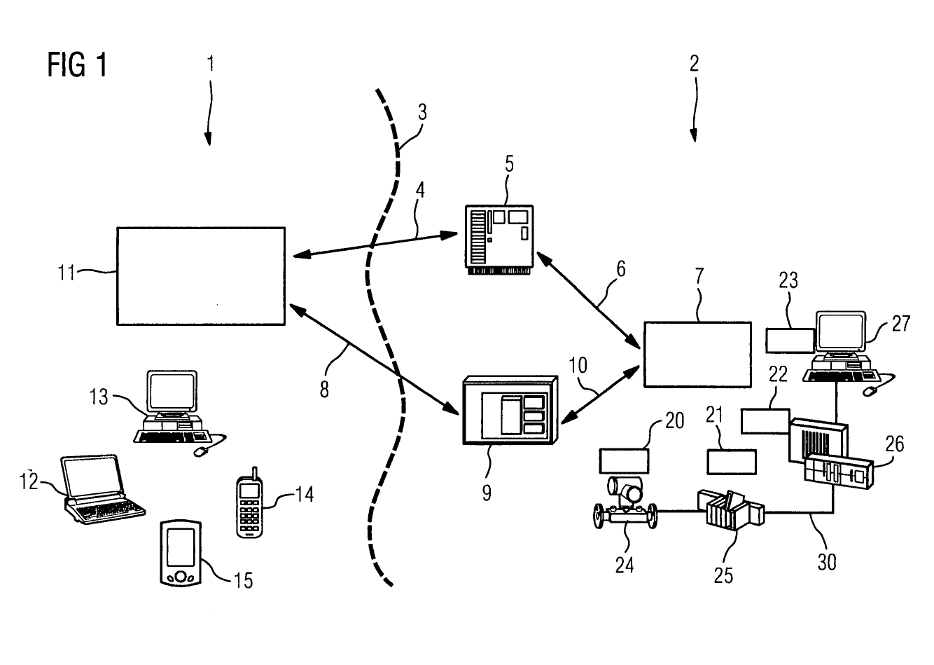

FIG. 1 shows an exemplary embodiment clarifying the principle of using web services in automation devices. A client side 1 is connected to a server side 2 over the internet and/or an intranet 3. A user 11 on the client side 1 can be embodied as, for instance, an application or browser. Said application or, as the case may be, browser can run on different platforms; shown here by way of example are a notebook 12, a personal computer (PC) 13, a mobile phone 14, and a personal digital assistant (PDA) 15. The user 11 communicates with the server side 2 over the internet and/or an intranet 3 and via HTTP connections 4 and 8. The server side 2 contains a PC-based web server 5 and an embedded web server 9. The web servers 5, 9 communicate with web services 7 via the connections 6 and 10 respectively. The web services 20 to 23 realized in an automation system are shown as examples of web services 7. The automation system in the exemplary embodiment contains a PC 27 which controls a system 24 via automation devices 25 and 26. Web services 20, 21, 22 and 23 are contained in the system 24, the automation devices 25, 26, and the PC 27, respectively.

The principle of using web services in automation devices is explained below with reference to FIG. 1. The components of the automation system 24 to 27 have in each case at least one interface for message-based and port-based accessing of at least one application provided by said component. Said applications are realized in the exemplary embodiment as web services. A web service of this type makes a certain functionality available, employs internet mechanisms, and is stateless. The interfaces of the automation system components are described using meta information. An interface can be implemented as, for example, an XML interface. The user 11 on the client side 1, which is to say an application or browser, can directly access the web services 7 or, as the case may be, 20 to 23 via an HTTP connection 4 or, as the case may be, 8 and a web server 5 or, as the case may be, 9.

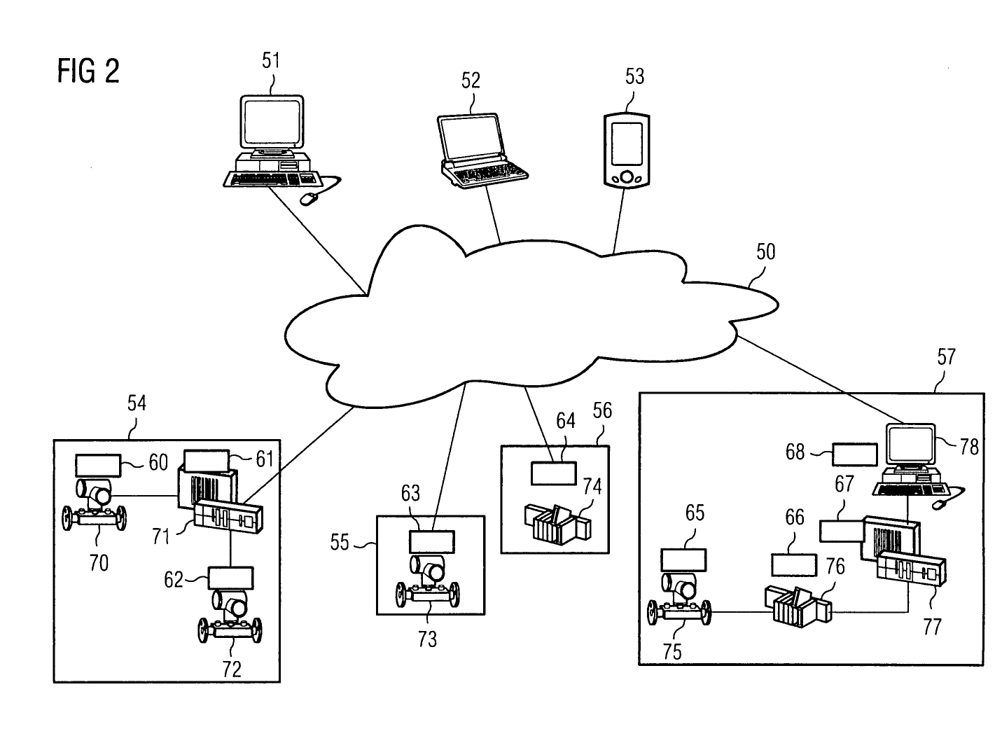

FIG. 2 shows the use of web services in a distributed automation system. The distributed system contains various operator control and monitoring systems 51 to 53 and distributed automation systems 54 to 57. Operator control and monitoring systems 51 to 53 and automation systems 54 to 57 communicate with each other over the internet and/or an intranet 50. The different automation systems 54 to 57 can be located on a distributed basis any distance from each other. The components 70 to 78 of the automation systems 54 to 57 are accessed via web services 60 to 68. The operator control and monitoring systems 51, 52, and 53 are implemented in the exemplary embodiment as part of an observation center or, as the case may be, as a mobile personal digital assistant of a service technician. However, communication over the internet and/or an intranet 50 takes place not only between the operator control and monitoring systems 51 to 53 and the automation systems 54 to 57 but also between the individual automation systems 54 to 57 or, as the case may be, between the components 70 to 78 of the automation systems.

Possible application scenarios for the invention and its embodiments are explained below. A first scenario describes a use for realizing a generic diagnostic system and an OC&M (OC&M=Operator Control and Monitoring) system. An application or, as the case may be, application component addresses all accessible automation systems via a standard interface (for diagnosis, for instance), calls up the relevant function there, and uses the supplied data for further processing purposes. Applications can here be located on a very wide variety of levels and can range from applications in the MES (Manufacturing Execution System) field and operator stations to applications for maintenance technicians (see FIG. 2). Location independence is made possible by the use of internet technologies. What are termed “Program Invocation Services” are realized in a second scenario. Programs can be launched in automation systems via standard mechanisms. Diagnosis can serve as an example of this. If diagnosis is launched in a “cell computer”, said computer can use the diagnostic functionality of subordinate devices to report compilations of information and more detailed diagnoses to the higher-ranking control system. Finally, a third scenario describes support for a maintenance technician when carrying out a diagnosis within a system. While inspecting the system, the maintenance technician can receive local information about devices, in particular automation devices. Said technician can fetch this from the automation devices directly with the aid of generic or special applications by addressing them directly. A very wide variety of mechanisms are possible here for addressing the automation devices, ranging from manually entering a device address (using a scanner, for instance), through to navigation via a central directory service, and on to recognizing the devices in the vicinity automatically (pico networks, for instance).

Further advantages of the invention and of its embodiments are described below. The approach of adapting the above-mentioned internet technologies for integration in automation systems is one particularly invited by a heterogeneous device landscape as is customary in automation technology. Functional accessing replaces the data-driven view of automation devices. The focus shifts from the data made available by an automation device to the functionality of the device. Devices are given functional interfaces providing access to the respective functions of the device (such as diagnostic functions, downloading, status, variable accessing). In contrast to previous OPC solutions, these functions are provided not by a PC but directly by the respective automation device itself. The following standard technologies from the desktop domain are among those employed for this:
Web service technology
RPC (Remote Procedure Calls) such as, for example, SOAP (Simple Object Access Protocol)
XML (Extended Markup Language)

When web service technology is used it is possible to call up objects/types/instance-specific functionality of a device. Use of the “stateless model” is one of the central technical prerequisites for employing web service technology. This prerequisite is met automatically by automation devices, where the state is represented by the state of the automation device itself. The respective web service is therefore stateless, which is to say it does not store any kind of information about a state, in particular the state of the respective automation device. Moreover, web services describe their functionality using standardized interface descriptions (WSDL, for example, standing for Web Service Description Language). This description suffices for a client to be able to call up the functionality. Owing to the technologies employed, clients are not restricted here to a specific platform (such as Windows, Unix, Linux, or RMOS, for instance). The advantages overall are these: Employing web service technology within the automation technology environment allows automation devices to be accessed uniformly using established standards. A manual is no longer essential for a description, but instead clients are able to implement accesses solely on the basis of the interface description. This makes it possible in particular to create transparency to desktop systems. This offers the major advantage of simplified integration both among themselves and with desktops or, as the case may be, over the internet. The effort and expense involved in realizing different client variants (desktop, intranet, internet) are reduced as no separate assessments are required in terms of local networks/internet, and different object models and paradigms. The synergy effects of existing solutions, such as firewall permeability and standard security mechanisms, can be used automatically thanks to the internet technologies employed. The range of clients that can be used is also extended, through the use of internet technologies, to include the handheld devices addressable over radio networks and pico networks (such as Bluetooth). This gives mobility for, for example, maintenance technicians. The key term here is “local cell communication” (diagnosis directly from any device on site). The invention furthermore provides the basis for defining standardized interfaces directly for the automation device (standard services, basic services, . . . ) without the need for proxies, data concentrators, OPC, etc. for accessing the device. This lays the foundations for a loosely coupled automation world. The individual automation devices contain everything necessary for operating autonomously within a network of automation devices (data, interfaces, interface description, and, where applicable, documentation on the device: “self-contained devices”). A further major advantage is the possibility for automation devices to communicate directly with other automation devices. This paves the way for totally new solutions. Automation devices can directly use services of other automation devices in their own applications. This communication is based on standard technologies as described above.

Adapting a standardized desktop technology for the automation world thus furnishes the basis for decentralized, platform-independent automation using standard technologies.

An overview of web service technology is given below to further explain the invention. This technology both allows applications (what are termed the services) to communicate with one another directly and permits applications to be built up from distributed components (services in this case, too), which is to say loosely associated web services can collaborate in order to fulfill a task. Web service technology scales with the aid of standards such as XML and SOAP from local communication up to communication over an intranet/the internet. It forms the basis of distributed and integrated internet applications, employing existing standards for these (for example W3C standards, IETF standards such as HTTP, XML, XML Schema, XML Data Types, etc.) or, as the case may be, new standards defined jointly with W3C and IETF such as SOAP, WSDL, and UDDI. Interfaces of web services are described by means of meta information (methods, parameters (names and types)), usually in WSDL (Web Service Description Language). This complete interface description suffices to call up the web services. It describes the end-point (port) on which the respective web service can be called up and is in particular useful for automatic communication with web services. Web services are characterized by simple access, with the boundaries between local APIs and web services (“web APIs”) being indistinct. Ease of access is similar to that when generating and using a local object. Web service technology thus forms the basis for loosely coupled applications. It is characterized by message-based communication and scalability due to statelessness. Loose coupling (with SOAP, for example) in particular offers the advantages of readily accommodating changes in the implementation of client and server and of robust communication (port-based, message-based, asynchronous). In message-based systems a client packs messages into self-describing packets (messages) and sends them in that form over the respective communication link. The only agreement between the sender and recipient relates to the message format used on the line. The only assumption is that the recipient will understand the message. No assumptions are made about what will happen after the message has been received or, as the case may be, between the sender and recipient. Customary web services have the following characteristics: They are accessible over a communication network such as the internet/an intranet and have an XML interface. Information about web services is stored in a registry so that said web services can be localized via this. They communicate with the aid of XML messages via web protocols and support loosely coupled connections between systems.

To summarize, the invention thus relates to an automation device 24 to 27 and to an automation system having automation devices 24 to 27 allowing automation devices to be integrated to provide a homogeneous automation solution. The automation devices 24 to 27 have at least one interface for message-based and port-based accessing of at least one application 20 to 23 provided by said automation device 24 to 27, with said application 20 to 23 making a functionality available and employing internet mechanisms, and with said interface being described using meta information. The applications 20 to 23 of the automation devices 24 to 27 in the automation system have means for communicating with one another directly.

1-8. (canceled)

9. An automation device comprising:
at least one interface for message-based and port-based accessing of at least one application provided by the automation device, wherein
the application provides a functionality and employs internet mechanisms, and wherein
the interface being described using meta information.

10. The automation device according to claim 9, wherein the application uses web service technology.

11. The automation device according to claim 9, wherein the application is stateless.

12. The automation device according to claim 10, wherein the application is stateless.

13. The automation device according to claim 9, wherein the interface is an XML interface.

14. The automation device according to claim 10, wherein the interface is an XML interface.

15. The automation device according to claim 11, wherein the interface is an XML interface.

16. The automation device according to claim 9, wherein a memory area is provided for storing information about the application.

17. The automation device according to claim 10, wherein a memory area is provided for storing information about the application.

18. The automation device according to claim 11, wherein a memory area is provided for storing information about the application.

19. The automation device according to claim 13, wherein a memory area is provided for storing information about the application.

20. An automation system comprising
at least one automation device, wherein the automation device comprises
at least one interface for message-based and port-based accessing of at least one application provided by the automation device, wherein
the application provides a functionality and employs internet mechanisms, wherein
the interface being described using meta information, and wherein
the application having a mechanism for directly communicating with another application.

21. The automation system according to claim 20, wherein distributed applications provide a common functionality.

22. The automation system according to claim 20, wherein a central component has an overview of existing automation devices and their properties.

23. The automation system according to claim 21, wherein a central component has an overview of existing automation devices and their properties.
